(19) United States
(12) Patent Application Publication
(10) Pub. No.: US 2022/0107132 A1
(43) Pub. Date: Apr. 7, 2022

(54) CUSTOMIZABLE FOOD ITEM DISPLAY

(71) Applicant: ELECTROLUX APPLIANCES AKTIEBOLAG, Stockholm (SE)

(72) Inventor: Michio Luis KOBAYASHI, Stockholm (SE)

(21) Appl. No.: 17/275,725

(22) PCT Filed: Sep. 19, 2018
(86) PCT No.: PCT/EP2018/075379

§ 371 Date: Mar. 12, 2021

(51) Int. Cl. F25D 29/00; G05B 15/02; G05D 23/19; H04W 4/80

(52) U.S. Cl. CPC F25D 29/00; G05B 15/02; G06K 19/0723; H04W 4/80; G05D 23/1905

(57) ABSTRACT

The invention relates to a method of configuring a household appliance (10) to display information about one or more food items (12a-12e) to be stored in the household appliance (10), and a household appliance (10) performing the method. In an aspect of the invention, a household appliance (10) configured to display information about one or more food items (i2a-i2e) to be stored in the household appliance (10) is provided. The appliance comprises an electronic display (11) configured to store information about said one or more food items (12a-12e) to be stored in the appliance (10), the information being received wirelessly by the electronic display (11), and further being configured to display at least a part of the received information.

### TECHNICAL FIELD

The invention relates to a method of configuring a household appliance to display information about one or more food items to be stored in the household appliance, and a household appliance performing the method.

### BACKGROUND

For household appliances storing food items, for instance a wine refrigerator storing wine bottles, keeping track of bottles stored in the fridge is a tedious process.

For a user wishing to display information about the wine bottles stored in the wine fridge, the user will have to print or handwrite tags or stickers and attach these to retainers holding the bottles in the wine fridge.

For an ever changing wine cellar, this is tedious and requires a lot of work and preparation, e.g. cleaning tags, removing existing stickers and printing new tags. It also requires resources such has paper tags, stickers, pens, printers, etc.

### SUMMARY

An object of the present invention is to solve, or at least mitigate, this problem in the art, and thus to provide an improved method of configuring a household appliance to display information about one or more food items to be stored in the household appliance.

This object is attained in a first aspect of the invention by a method of configuring a household appliance to display information about one or more food items to be stored in the household appliance. The method comprises wirelessly receiving, at an electronic display comprised in the household appliance, information about said one or more food items to be stored in the household appliance, storing the received information, and displaying at least a part of the received information on the electronic display.

This object is attained in a second aspect of the invention by a method of configuring a household appliance to display information about one or more food items to be stored in the household appliance using a wireless communication device. The method comprises wireless transmitting, from the wireless communication device to an electronic display comprised in the household appliance, information about said one or more food items to be stored in the household appliance, wherein the electronic display subsequently displays at least a part of the received information.

This object is attained in a third aspect of the invention by a household appliance configured to display information about one or more food items to be stored in the household appliance. The household appliance comprises an electronic display configured to store information about said one or more food items to be stored in the appliance, the information being received wirelessly by the electronic display, and further being configured to display at least a part of the received information.

With the invention, an electronic display is attached to e.g. a retainer of a household appliance configured to store food items. In an exemplifying embodiment, the household appliance is a wine refrigerator storing food items in the form of wine bottles. However, it is noted that in another envisaged embodiment, the appliance is a regular fridge storing food items such as fruit and vegetables, canned goods, milk cartons, meat, cheese, etc.

The electronic display may for instance be embodied by a near-field communication (NFC) enabled display, such as an e-paper or e-ink display, for wireless communication with a device such as a smart phone. An advantage of using an NFC display is that such a display does not have to be powered from its own source but harvests energy from e.g. the smart phone upon performing a communication session, or from the household appliance itself. Alternatively, a display capable of communicating via Radio Frequency Identification (RFID) is envisaged.

The user customizes the electronic display by transferring information to be displayed from for instance a smart phone, whereupon the electronic display receives the information, stores it and displays at least a part of the information.

Advantageously, instead of having a user print or handwrite tags or stickers and attaching these to the retainers of for example a wine fridge, which is a tedious process for an ever changing wine cellar, the customizable electronic display provided by the invention greatly simplifies for a user to dynamically update her wine cellar and have the display show information associated with wine bottles stored in the fridge.

In an embodiment, the electronic display is configured to display the received information in connection to a food item for which the information is received.

In an embodiment, the received information identifies one or more food items and their storage position in the appliance.

In an embodiment, the electronic display is further being configured to wirelessly communicate the stored information to a receiving device, being for instance a smart phone or the household appliance itself. Further, the receiving device is not necessarily the device which was used to transfer information to the electronic display.

In an embodiment, the electronic display is configured to receive the information from a wireless communication device, from the household appliance, or from said one or more food items being equipped with a tag capable of communication by means of NFC or RFID technology.

In an embodiment, the electronic tag is configured to store information pertaining to a date at which said one or more food items were placed for storage in the household appliance.

In an embodiment, the electronic display is configured to store information pertaining to a preferred temperature at which one or more wine bottles are to be stored, and is further configured to communicate the temperature information to a controller of the wine refrigerator for setting the temperature of one or more temperature zones in the wine refrigerator.

In an embodiment, the electronic display is configured to store information pertaining to a preferred temperature at which one or more wine bottles are to be stored, and is further configured to communicate the temperature information to a controller of the wine refrigerator. The controller is configured to determine a physical location in the wine refrigerator where the one or more wine bottles should be stored such that the preferred temperature is complied with. The electronic display receives information from the controller of the wine refrigerator indicating the physical location in the wine refrigerator where said one or more wine bottles should be stored based on the preferred temperature, and displays the location information to a user.

Further embodiments will be discussed in the following.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 illustrates a customizable electronic display to be used in a wine refrigerator according to an embodiment;

FIG. 2 illustrates a flowchart of a method of configuring an electronic display according to the embodiment described with reference to FIG. 1;

FIG. 3 illustrates a wine refrigerator in which the electronic display is implemented according to an embodiment;

FIG. 4 illustrates a flowchart of a method of configuring an electronic display to also communicate a preferred temperature at which a wine bottle should be stored according to an embodiment; and

FIG. 5 illustrates a flowchart of a method of configuring an electronic display to also communicate a preferred temperature at which a wine bottle should be stored according to another embodiment.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

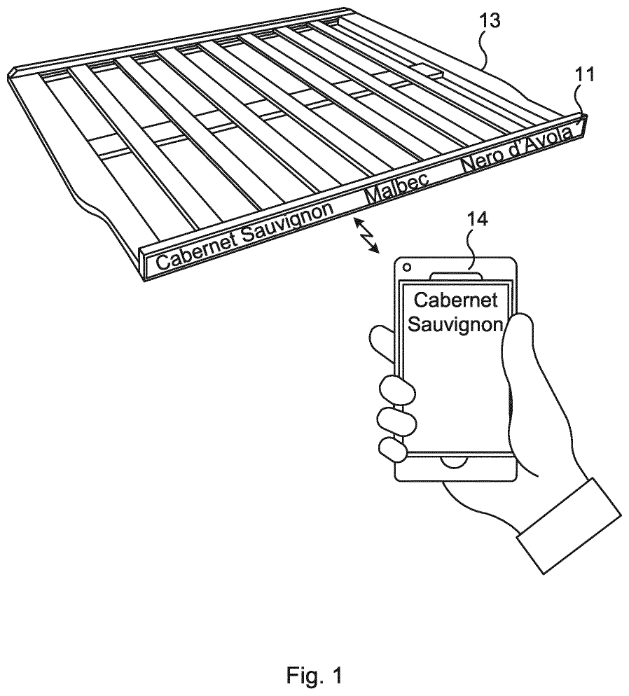

FIG. 1 illustrates an embodiment of the invention, where an electronic display 11 is attached to a retainer 13 of a household appliance configured to store food items.

In this particular embodiment, the household appliance is a wine refrigerator storing food items in the form of wine bottles. However, it is noted that in another envisaged embodiment, the appliance is a regular fridge storing food items such as fruit and vegetables, canned goods, milk cartons, meat, cheese, etc.

The electronic display may 11 for instance be embodied by a near-field communication (NFC) enabled display, such as an e-paper or e-ink display, for wireless communication with a device such as a smart phone. An advantage of using an NFC display is that such a display does not have to be powered from its own source but harvests energy from e.g. the smart phone upon performing a communication session, or from the household appliance itself. Alternatively, a display capable of communicating via Radio Frequency Identification (RFID) is envisaged.

In this exemplifying embodiment, the user customizes the electronic display 11 by transferring grape variety names (Cabernet Sauvignon, Malbec and Nero d'Avola) from the smart phone 14 to the display 11.

The electronic display 11 receives the information, stores it and displays at least a part of the information.

The user may then place bottles on the retainer 13 in accordance with the information provided by the smart phone 14 and displayed by the display 11;

the first three bins are indicated to hold bottles of wine made from Cabernet Sauvignon, the next two bins will hold a wine made from Malbec and the last three bins are designated to hold a wine made from Nero d′Avola.

As is understood, this is just one example of configuring the display 11 to display data provided wirelessly from a device such as a smart phone 14: the display 11 may be configured to display far more details than what is shown in FIG. 1, such as name of the particular wine producer, date at which the bottle was placed in the fridge, retail price, etc.

Advantageously, instead of having a user print or handwrite tags or stickers and attaching these to the retainers of a wine fridge, which is a tedious process for an ever changing wine cellar, the customizable electronic display provided by the invention greatly simplifies for a user to dynamically update her wine cellar and have the display show information associated with wine bottles stored in the fridge.

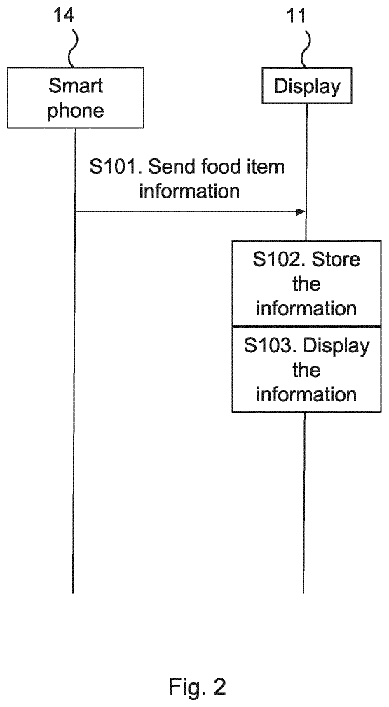

FIG. 2 illustrates a flowchart of a method of configuring an electronic display according to the embodiment discussed with reference to FIG. 1.

Hence, in a first step S101, the user transmits grape variety names (Cabernet Sauvignon, Malbec and Nero d′Avola) from the smart phone 14 to the display 11.

In a second step S102, the electronic display 11 stores the received information, and then displays at least a part of the received information in step S103. As is understood, the electronic display 11 may receive information which not necessarily is displayed to the user.

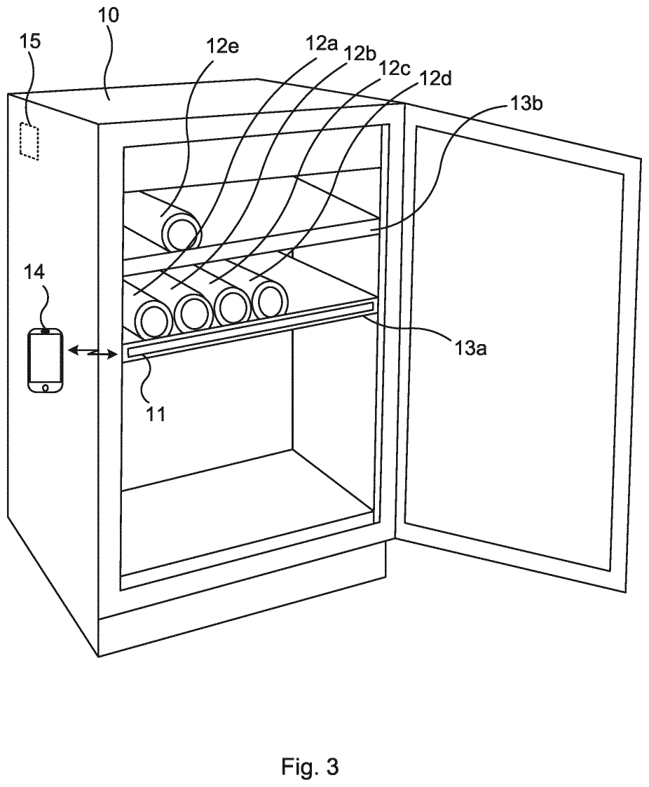

FIG. 3 illustrates a household appliance configured to store food items according to another embodiment. Again, the household appliance is a wine refrigerator storing food items in the form of wine bottles.

The wine fridge 10 of FIG. 1 comprises at least one electronic display 11 capable of displaying information to a user and storing information about the bottles 12a-12d stored on retainers 13a, 13b in the wine fridge 10, the at least one display may be attached to a retainer 13a or a chassis of the fridge 10. In this particular example, the electronic display 11 extends along the length of the first retainer 13a.

It is understood that the fridge 10 may comprise a plurality of electronic displays 11 storing information, for instance one display attached to each retainer 13a, 13b, a number of displays attached to a single retainer, or even one electronic displays for each bin of each retainer in which case it is possible to display highly detailed information for each individual wine bottle stored in the fridge 10.

Further, the fridge 10 comprises a controller 15, such as e.g. a microprocessor, for handling any communication with the electronic display 11 and the smart phone 14, for controlling temperature of different temperature zones, etc.

In this exemplifying embodiment, one display is attached to first retainer 13a, while second retainer 13b is not equipped with a display.

In this embodiment, upon a user placing a bottle in the fridge 10, the user transfers information identifying the bottle to be placed on a retainer 13a, 13b from the smart phone 14 to the display 11.

Assuming that the user places a first bottle 12a in a first bin of the first retainer 13a; the user may thus transfer information such as wine name, grape variety, vintage and location of the bottle in the fridge 10 e.g. by entering the entering information in a wine fridge app of the smart phone 14.

The information may be entered manually by the user in the app, or the information may partially or fully be acquired from a wine database such as Cellartracker, or a camera of the smart phone may be used to scan a bar code of the first bottle 12a for the information.

In an alternative embodiment, the information is not transferred to the display 11 from the smart phone 14, but from e.g. an RFID tag attached to a bottle being placed in the fridge 10. It may further be envisaged that information is transferred to the electronic display 11 from both RFID tags attached to bottles and a smart phone. For instance, the information pertaining to name of producer, vintage, grape variety, etc., is transferred from the RFID tag of the bottle, while the smart phone transmits information indicating the check-in time of the bottle in the fridge.

In a further embodiment, the electronic display 11 is configured to receive information from the household appliance 10, such as for instance temperature indications of different temperature zones in the appliance, or error messages.

The information to be provided to the electronic display 11 may e.g. have the form:
[Château Pétrus, Merlot, 2012, Retainer 1, Bin 1]

The user transfers the information from her smart phone to the electronic display 11 and places the bottle in the first bin of the first retainer 13a, while the information is displayed on the electronic display 11 at a location where the first bin is situated such that a user easily can see with which bin (and bottle) the information is associated.

It may further be envisaged that the electronic display 11 stores further information which supplements the information received from the smart phone, such as date and time when the first bottle 12a was placed in the fridge 10 (referred to in the following as “check-in data”). This may be advantageous for reasons of provenance in case of storing high-value wines which subsequently may be sold.

In another example, a second bottle 12e is placed in a third bin of the second retainer 13b, where the information provided from the smart phone to the display 11 again consists of wine name, grape variety, vintage and bottle location:
[Stoneleigh, Pinot Noir, 2016, Retainer 2, Bin 3]

The information is displayed on the electronic display 11 at a location where the third bin is situated such that a user easily can see with which bin the information is associated. In case the second retainer 13b is not equipped with an electronic display, the electronic display 11 attached to the first retainer 13a may indicate with which particular retainer a bottle is associated.

The information associated with each bottle 12a-12e and stored in electronic display 11 will subsequently be useful for stock-keeping purposes; the user may have tens or hundreds of bottles stored in a wine fridge and may want to have more or less detailed information about the bottles being stored.

The user may easily acquire any information stored in the display 11 for a particular bottle or for a group of bottles by establishing communication between the smart phone 14 and the electronic display 11.

For instance, assuming that the user intends to open a bottle of wine made from the Pinot Noir grape; the user may then query the display 11 by entering such an option in the app of the smart phone 14 (“Show Pinot Noir wines”). The display 11 may subsequently return the information to the smart phone 14.

In an example, the display 11 responds to the query by sending the following information to the smart phone 14: retainer 1: bin 1, bin 3; retainer 2: bin 2, bin 4, in addition to displaying the information. The user may hence swiftly grab a bottle from any one of these locations in the wine fridge 10.

Should each retainer be equipped with an electronic display, the positions on the displays corresponding to bin 1 and bin 3 for the first retainer 13a and bin 2 and bin 4 for the second retainer 13a could indicate to the user in an appropriate manner that those particular bins hold a Pinot Noir wine.

Alternatively, the display 11 may display the above information: “Pinot Noir in retainer 1, bin 1, bin 3, retainer 2, bin 2, bin 4”

In a further embodiment, in case the wine fridge 10 has different temperature zones, the electronic display 11 may even receive (from an RFID tag of the bottle or from the smart phone) information regarding preferred temperature at which the wine should be stored, which may be useful for the wine fridge controller 15 controlling the temperature to be set in the different zones, the controller 15 being capable of communicating with the electronic display.

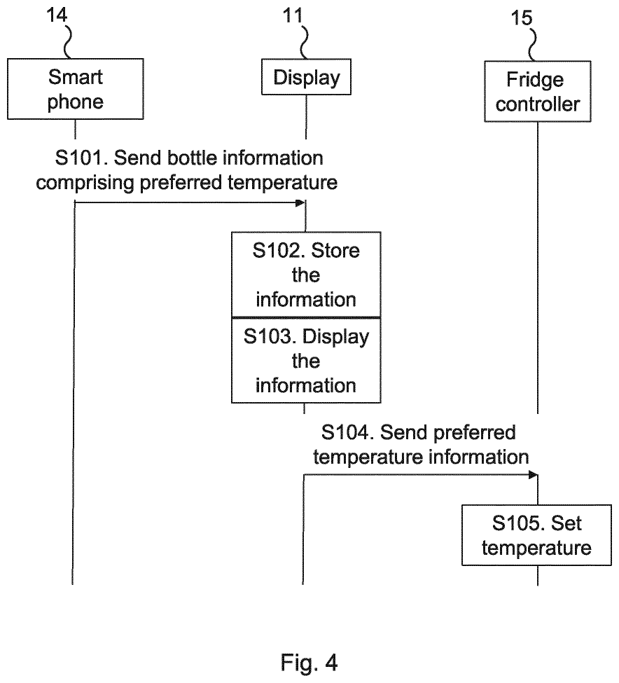

FIG. 4 illustrates a flowchart of a method of configuring an electronic display to also communicate a preferred temperature at which a wine bottle should be stored according to an embodiment.

Hence, in a first step S101, the user transmits information regarding a bottle to be stored in the fridge 10 using her smart phone 14:
[Cháteau Pétrus, Merlot, 2012, Retainer 1, Bin 1, 15° C.].

The electronic display 11 stores the information in step S102 and displays a part of the information in step S103, in this example “Cháteau Pétrus, Merlot, 2012, Retainer 1, Bin 1” but not the preferred storage temperature.

Thereafter, the electronic display 11 communicates the temperature information to a controller 15 of the wine fridge 10 in step S104. Upon receiving the information, the controller 15 may in step S105 set the temperature of the zone in which the bottle is stored to 15° C.

It is further envisaged that the electronic display 11 receives (and displays) information from the wine fridge 11 as to where the bottle should be placed depending on the preferred temperature at which the bottle should be stored. For instance, assuming that the fridge 10 has two different zones where the temperature of a first zone is set to 10° C., while the temperature of a second zone is set to 15° C. If the preferred storage temperature of the bottle to be stored is, say 10-11° C., the fridge 10 will indicate on the electronic display 11 that the bottle should be placed in a location of the first temperature zone.

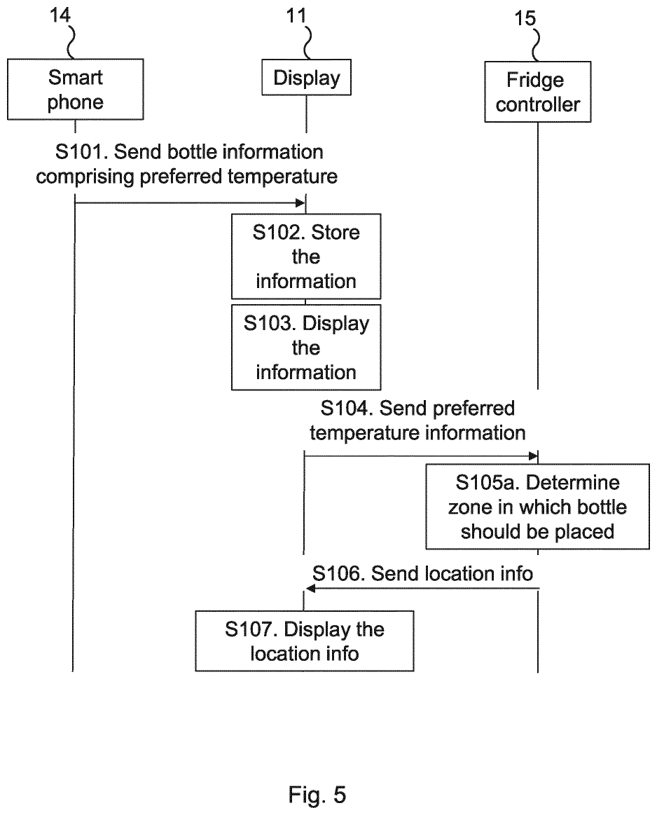

FIG. 5 illustrates a flowchart of a method of configuring an electronic display to also display where to store a bottle based on preferred storage temperature according to an embodiment.

Hence, in a first step S101, the user transmits information regarding a bottle to be stored in the fridge 10 using her smart phone 14 (or by supplying the bottle with an RFID tag comprising the information):
[Cháteau Pétrus, Merlot, 2012, 15° C.].

The electronic display 11 stores the information in step S102 and displays a part of the information in step S103, in this example “Cháteau Pétrus, Merlot, 2012, 15° C.”.

Thereafter, the electronic display 11 communicates the temperature information to a controller 15 of the wine fridge 10 in step S104. Upon receiving the information, the controller 15 determines in step S105a where the bottle should be placed such that the bottle can be stored at the preferred temperature. For instance, the controller 15 may determine that the bottle should be placed in retainer 1, bin 3.

The controller 15 communicates the location information to the electronic display 11 in step S106 which accordingly displays the location information “retainer 1, bin 3” in step S107 to the user, possibly in combination with the information displayed in step S103. Advantageously, the user is informed as to where the bottle should be placed in the fridge 10 such that the preferred storage temperature is complied with.

The invention has mainly been described above with reference to a few embodiments. However, as is readily appreciated by a person skilled in the art, other embodiments than the ones disclosed above are equally possible within the scope of the invention, as defined by the appended patent claims.

1. A method of configuring a household appliance (10) to display information about one or more food items (12a-12e) to be stored in the household appliance (10), the method comprising:
wirelessly receiving (S101), at an electronic (11) display comprised in the household appliance (10), information about said one or more food items (12a-12e) to be stored in the household appliance (10);
storing (S102) the received information; and
displaying (S103) at least a part of the received information on the electronic display (11).

2. A method of configuring a household appliance (10) to display information about one or more food items (12a-12e) to be stored in the household appliance (10) using a wireless communication device (14), the method comprising:
wireless transmitting (S101), from the wireless communication device (14) to an electronic display (11) comprised in the household appliance (10), information about said one or more food items (12a-12e) to be stored in the household appliance (10), wherein the electronic display (11) subsequently displays at least a part of the received information.

3. The method of claim 1, wherein the electronic display (11) is configured to display the received information in connection to a food item for which the information is received.

4. The method of claim 1, said received information identifying said one or more food items (12a-12e) and their storage position in the appliance (10).

5. The method of claim 1, the electronic display (11) further being configured to wirelessly communicate the stored information to a receiving device.

6. A household appliance (10) configured to display information about one or more food items (12a-12e) to be stored in the household appliance (10), comprising:
an electronic display (11) configured to store information about said one or more food items (12a-12e) to be stored in the appliance (10), the information being received wirelessly by the electronic display (11), and further being configured to display at least a part of the received information.

7. The household appliance (10) of claim 6, further comprising:
retainers (13a, 13b) for storing said one or more food items (12a-12e); wherein
the electronic display (11) is configured to store information identifying said one or more food items (12a-12e) and their storage position in the appliance (10).

8. The household appliance (10) of claim 5, the electronic display (11) being configured to receive the information from a wireless communication device (14), from the household appliance (10), or from said one or more food items (12a-12e) being equipped with a tag capable of communication by means of Near Field Communication (NFC) or Radio Frequency Identification (RFID) technology.

9. The household appliance (10) of claim 6, the electronic display (11) being configured to wirelessly communicate the stored information to a receiving device.

10. The household appliance (10) of claim 6, the electronic tag (11) being configured to store information pertaining to a date at which said one or more food items (12a-12e) were placed for storage in the household appliance (10).

11. The household appliance (10) of claim 6, the household appliance (10) being a wine refrigerator.

12. The household appliance (10) of claim 11, the electronic display (11) being configured to store information pertaining to a preferred temperature at which one or more wine bottles (12a-12e) are to be stored, and further being configured to:
communicate (S104) the temperature information to a controller (15) of the wine refrigerator (10) for setting the temperature of one or more temperature zones in the wine refrigerator (10).

13. The household appliance (10) of claim 11, the electronic display (11) being configured to store information pertaining to a preferred temperature at which one or more wine bottles (12a-12e) are to be stored, and further being configured to:
communicate (S104) the temperature information to a controller (15) of the wine refrigerator (10);
determine (S105a), at the controller (15), a physical location in the wine refrigerator (10) where the one or more wine bottles (12a-12e) should be stored such that the preferred temperature is complied with;
receive (S106) further information from the controller (15) of the wine refrigerator (10) indicating the physical location in the wine refrigerator where said one or more wine bottles (12a-12e) should be stored based on the preferred temperature; and
display (S107) said further information.
